(19) United States
(12) Patent Application Publication
(10) Pub. No.: US 2009/0149617 A1
(43) Pub. Date: Jun. 11, 2009

(54) SHAPE MEMORY POLYMER MATERIALS WITH CONTROLLED TOUGHNESS AND METHODS OF FORMULATING SAME

(75) Inventors: Kenneth Allen Gall, Atlanta, GA (US); David Lee Safranski, Newark, DE (US)

Correspondence Address: GREENBERG TRAURIG, LLP, 1200 SEVENTEENTH STREET, SUITE 2400, DENVER, CO, 80202, US

(73) Assignees: Keneth Allen Gall, Atlanta, GA (US); David Lee Safranski, Newark, DE (US)

(21) Appl. No.: 12/324,839

(22) Filed: Nov. 27, 2008

Related U.S. Application Data
(60) Provisional application No. 60/990,568, filed on Nov. 27, 2007.

(51) Int. Cl. C08F 220/26; C08F 118/14; C08F 118/02

(52) U.S. Cl. 526/320; 526/326; 526/319

(57) ABSTRACT

The disclosure relates to shape memory polymer (SMP) networks formed using acrylate-based monomers. As disclosed herein, proportional dependence between toughness and C_{∞} value may be broken in acrylate-based shape memory polymers comprising mono-functional acrylates which are controllably crosslinked using a crosslinker such as poly(ethylene glycol) di-methacrylate (PEGDMA) with an average molecular weight of 550 (PEGDMA 550). Through the controlled addition of a crosslinker, the relationship between the C_{∞} value and toughness can be manipulated (e.g., proportional relationships may be destroyed and/or reversed) in acrylate-based SMP networks.

### RELATED APPLICATIONS

This application claims the benefit of and priority to U.S. Provisional Application Ser. No. 60/990,568, filed on Nov. 27, 2007.

### BACKGROUND

Shape memory polymer (SMP) materials offer the ability to activate with a mechanical force under the application of a stimulus. The stimulus may be light, heat, other types of energy, or other types of stimuli known in the art.

### SUMMARY

Novel SMP material formulations and techniques are described herein for controlling toughness properties of the SMP with novel relationships between toughness of the SMP, cross-linking density of the SMP, and the characteristic ratio of the linear builder of the SMP.

In one aspect, the disclosure describes a shape memory polymer including a linear builder with a characteristic ratio above about 9, wherein the shape memory polymer exhibits a toughness value over about 0.2 megajoules per cubic meter.

### BRIEF DESCRIPTION OF THE DRAWINGS

FIG. 1 shows experimental results outlining the effect of crosslinking on failure strain for different SMPs comprising either BMA, 2EEM, or tBA as a linear builder.

FIG. 2 shows experimental results outlining the effect of crosslinking on toughness for different SMPs comprising either BMA, 2EEM, or tBA as a linear builder.

FIG. 3 shows experimental results outlining the effect of crosslinking on both failure strain and toughness as shown through the stress-strain relationships in strain-to-failure tests of different SMPs comprising either BMA, 2EEM, or tBA as a linear builder.

### DETAILED DESCRIPTION

Shape memory acrylate networks are novel materials for both biomedical and industrial applications. The strain to failure is useful because it is pivotal to know how much recovery strain the material experiences. To understand how the structure is related to mechanical properties, such as strain to failure, materials of differing chain stiffness ratio, C_{∞}, are compared at varying percentages of cross-linker. First, a set of networks is characterized to understand the trends in the basic thermo-mechanical properties of the monomers once cross-linked. Thirty-one acrylates are separated into two groups: linear chain builders having one functional group (e.g., mono-functional acrylates), and cross-linkers having two or more functional groups (e.g., multi-functional acrylates). The networks are systematically synthesized by varying the linear chain builders with poly(ethylene glycol) di-methacrylate Mn˜550 (PEGDMA550) as the cross-linker, and varying the cross-linker while holding tert-butyl acrylate constant as the linear chain builder. A dynamic mechanical analyzer evaluates the glass transition temperature, rubbery modulus, and spread of tan delta. Subsequently, strain to failure tests are performed at the glass transition temperature of each respective mixture. The linear chain builders with PEGDMA550 have glass transition temperatures ranging from −29 to 112° C., and rubbery moduli from 2.75 to 17.5 megapascals (MPa). The addition of sidegroups like methyl groups or large ringed structures close to the functional group increased the glass transition temperature. The cross-linkers co-polymerized with tert-butyl acrylate have glass transition temperatures ranging from −3 to 98° C., and rubbery moduli from 6 to 130 MPa. As the functionality of the cross-linker increases, the rubbery modulus increases due to the increased cross-linking density. With this ‘library’ of networks, materials can be selected to independently vary the glass transition temperature and rubbery modulus. Based upon the initial screening results, networks with different C_{∞} are formed at varying percentages of cross-linker. C_{∞} values typically apply only for pure linear chain builders, not networks, and here we demonstrate how chemical cross-linking alters the impact of C_{∞} on strain to failure. The comparison of these networks yields insight into the relationship between chemical structure and mechanical properties leading to a relationship between C_{∞}, percentage cross-linker, and strain to failure.

In developing prior art thermosets, toughness may be affected by linear builder parameters, including the C_{∞} value. As used herein, the term C_{∞} value (characteristic ratio) is a dimensionless ratio known to those with skill in the art as a characteristic of a polymer chain formed from a linear builder. As used herein, the term linear builder is used to describe a mono-functional monomer which may be used to form a portion of a thermoplastic or which may be cross-linked with a crosslinker into a thermoset. Examples of acrylate-based linear builders include: methyl acrylate; methyl methacrylate; butyl acrylate; tert-butyl acrylate (e.g., tBA); tert-butyl methacrylate; 2-ethoxyethyl methacrylate (e.g., 2EEM); isobornyl methacrylate; 2-ethylhexyl methacrylate; isodecyl acrylate; benzyl methacrylate (e.g., BMA); ethylene glycol phenyl ether methacrylate; poly(propylene glycol) acrylate; poly(ethylene glycol)-phenyl ether acrylate (with average molecular weight 236); poly(ethylene glycol)-phenyl ether acrylate (with average molecular weight 280); poly(ethylene glycol)-phenyl ether acrylate (with average molecular 324); and other acrylate-based linear builders.

As examples, the following figures provide data on SMPs created with a particular linear builders (e.g., BMA, tBA or 2EEM) using the techniques disclosed herein. BMA has a C value of 13.67. 2EEM has a C_{∞} value of 11.98. tBA has a C_{∞} value of 9.47.

Average molecular weights of cross-linker material (e.g., Mn, “mol. weight”) may be referred to herein as simply molecular weight or weight of cross-linker. The term average molecular weight may refer to a cross-linker material that has a majority of molecules with that molecular weight. The term may also refer to a cross-linker material that contains substantially no molecules with that particular weight. For example, a mixture of PEG with a molecular weight of 330 and PEG with a molecular weight of 500 may result in a mixture of PEG with an average molecular weight of 415. Other mixing ratios may be used to attain other average molecular weights.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

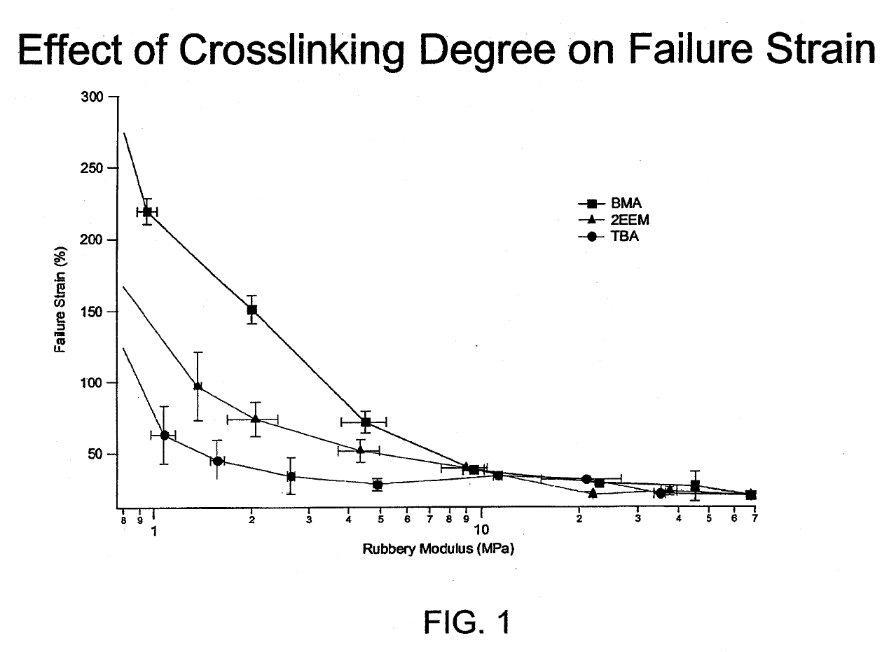

FIG. 1 shows experimental results outlining the effect of crosslinking on failure strain for different SMPs comprising either BMA, 2EEM, or tBA as a linear builder. The SMPs created from BMA are denoted with squares and show a failure strain which is higher than the failure strains of the SMPs created with other linear builders and with comparable rubbery moduli. Therefore, the SMPs created with BMA as a linear builder may show a greater failure strain (e.g., extensibility) than SMPs with similar rubbery moduli created from either 2EEM or tBA. At rubbery moduli greater than about 10 MPa, the differences in failure strain of the SMPs becomes inconsistent and/or obscured.

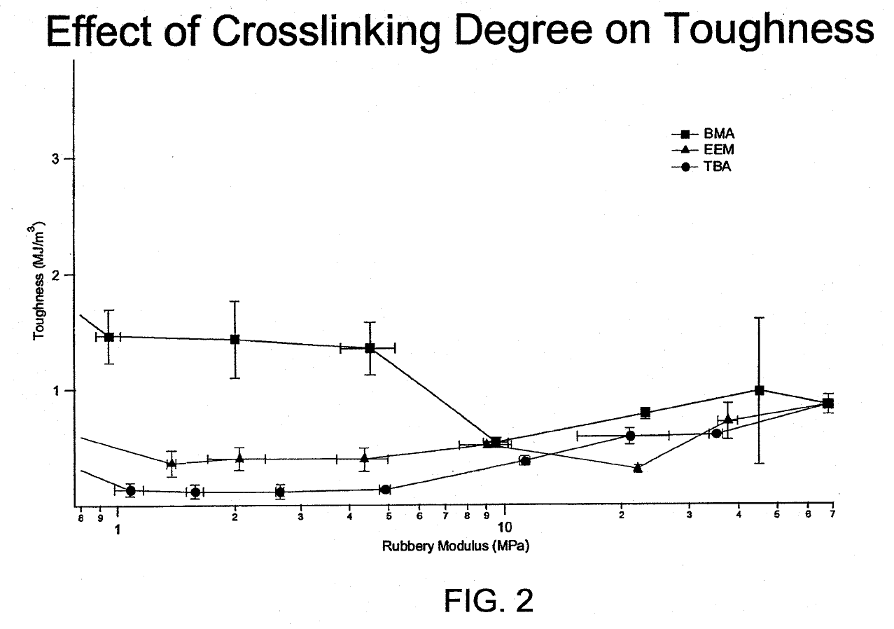

FIG. 2 shows experimental results outlining the effect of crosslinking on toughness for different SMPs comprising either BMA, 2EEM, or tBA as a linear builder. The SMPs created from BMA are denoted with squares and show a toughness value which is higher than the toughness values of the SMPs created with other linear builders and with comparable rubbery moduli. Therefore, the SMPs created with BMA as a linear builder may show a greater toughness value (e.g., integral of a stress-strain curve) than SMPs with similar rubbery moduli created from either 2EEM or tBA. At rubbery moduli greater than about 10 MPa, the differences in toughness of the SMPs becomes inconsistent and/or obscured.

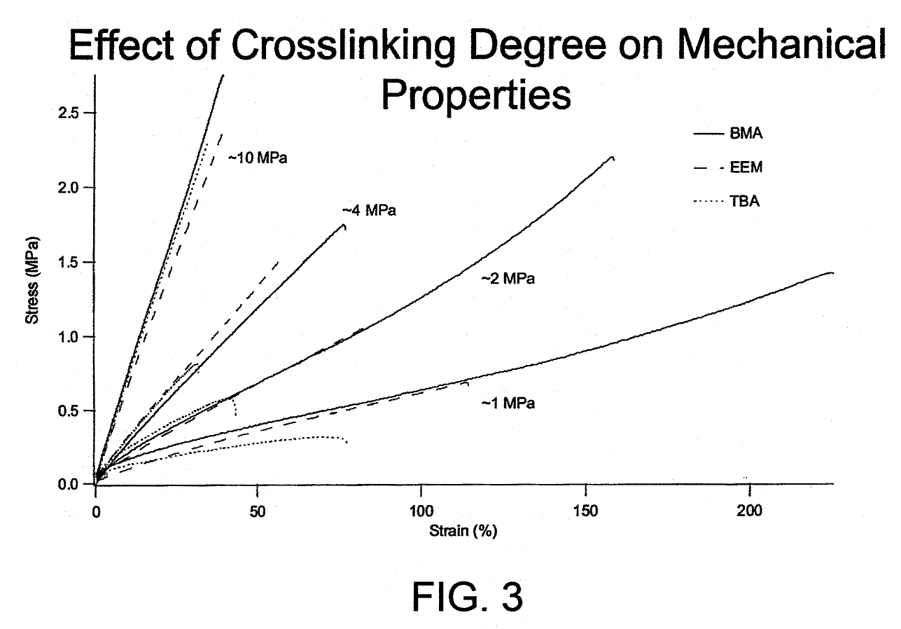

FIG. 3 shows experimental results outlining the effect of crosslinking on both failure strain and toughness as shown through the stress-strain relationships in strain-to-failure tests of different SMPs comprising either BMA, 2EEM, or tBA as a linear builder. The strain-to-failure tests plotted as stress-strain curves demonstrate the comparable toughness values for the different SMPs and while also demonstrating the ultimate failure strains capable by the different SMPs. For the SMPs with a rubbery modulus of 10 MPa, the toughness and strain to failure values are shown converging as described further herein. For SMPs with lower rubbery modulus, the strain to failure and toughness differences become much larger and distinct, varying with respect to the C_{∞} value as described further herein.

As noted above, BMA has a higher C_{∞} value than both 2EEM and tBA. However, a higher C_{∞} value is understood by the prior art to dictate a lower failure strain and a lower toughness. Through the techniques described herein, a higher C_{∞} value for a linear builder may be used to create a higher failure strain and/or higher toughness for an SMP comprising an acrylate-based linear builder.

For certain ranges of crosslinking density, (e.g., as evidenced by a certain range of rubbery modulus), distinctions of failure strain and toughness become obscured between acrylate-based SMP networks comprising different linear builders with different C infinity values. For example, for crosslinking densities that result in rubbery moduli greater than 10 MPa, there is little discernable difference in either failure strain or toughness between acrylate-based SMP networks comprising the linear builders, as disclosed herein. These compositions with greater than 10 MPa, where distinctions between SMPs become obscured, may be termed a convergence point of the properties of the SMPs. Before the convergence point, the properties of the different SMPs shown in the figures are unpredictable by prior art methods. Specifically, through the techniques described herein, and contrary to the prior art prediction, the toughness of the SMPs before the convergence point fails to vary proportionally with the C_{∞} value of the linear builder in the SMP.

In addition, as disclosed herein, benzene rings are added as side groups to linear builders in order to increase toughness. Prior art predictions indicate that an additional benzene ring in the main chain (e.g., the “backbone”) of the linear builder will produce gains in toughness through decreases in C_{∞}. However, using a linear builder with a benzene ring as a side group, while controlling crosslinking with the introduction of a crosslinker, such as PEGDMA, increases toughness in the resulting SMP. The addition of a benzene ring side group raises the C_{∞} value of the linear builder and, as described above, modifies the expected properties of a SMP in which the linear builder is included. Prior art based on the C_{∞} concept would have predicted a decrease in toughness with an increase in the C_{∞} value, although here for shape memory polymer networks we demonstrate an increase in toughness.

A method is contemplated for selecting and determining a composition of a SMP including an acrylate-based linear builder based on the unexpected findings described above. The method may be used to determine properties of an SMP based on the composition of the SMP formulation. The method may include identifying a reference SMP formulation, which produces a reference SMP with reference properties. The method may further include determining a modification to the reference SMP formulation through any of the relationships disclosed herein. For example, an increased toughness SMP formulation may be determined based on a selected linear builder with an increased C_{∞} value. As another example, a decreased toughness SMP formulation may be determined based on a selected linear builder with a decreased C_{∞} value. As another example, an SMP formulation may be developed wherein the prior art relationship between C_{∞} and toughness and/or the prior art relationship between C_{∞} and failure strain is/are reversed and/or otherwise modified. Another example would include using an SMP formulation with a linear builder with a specific chemistry, such as a benzene ring, or other side chain group. Some methods may further include steps to determine a rubbery modulus for any modified SMP formulation to determine the magnitude of the relationships disclosed herein and/or if the modified SMP formulation will result in a rubbery modulus past a convergence point.

Additional support for and description of the systems, compositions and methods are described in the following attachments and slides, which constitute part of this disclosure.

What is claimed is:

1. A shape memory polymer, comprising:
a linear builder with a characteristic ratio above about 9; and
wherein the shape memory polymer exhibits a toughness value over about 0.2 megajoules per cubic meter.

2. The shape memory polymer of claim 1, wherein the shape memory polymer exhibits a rubbery modulus of less than about 10 megapascals.

3. The shape memory polymer of claim 1, wherein the characteristic ratio is above about 11.

4. The shape memory polymer of claim 3, wherein the characteristic ratio is above about 13.

5. The shape memory polymer of claim 1, wherein the toughness value is above about 0.4 megajoules per cubic meter.

6. The shape memory polymer of claim 5, wherein the toughness value is above about 1.5 megajoules per cubic meter.

7. The shape memory polymer of claim 1, wherein the linear builder comprises a benzene ring in a side group of the linear builder.

8. The shape memory polymer of claim 1, further comprising:
a crosslinker with a mol percentage of less than about 10 percent.

9. The shape memory polymer of claim 8, wherein the crosslinker is poly-ethylene glycol di-methacrylate.

10. The shape memory polymer of claim 9, wherein the poly-ethylene glycol di-methacrylate has a molecular weight of above about 550.

11. The shape memory polymer of claim 1, wherein the linear builder is benzyl methacrylate.

12. The shape memory polymer of claim 1, wherein the linear builder is 2-ethoxyethyl methacrylate.

13. The shape memory polymer of claim 1, wherein the linear builder is tert-butyl acrylate.
